(19) United States
(12) Patent Application Publication
(10) Pub. No.: US 2020/0253171 A1
(43) Pub. Date: Aug. 13, 2020

(54) Apparatus for live bait aeration

(71) Applicant: Tim Bement, Breezy Point, MN (US)

(72) Inventor: Tim Bement, Breezy Point, MN (US)

(21) Appl. No.: 16/786,485

(22) Filed: Feb. 10, 2020

Related U.S. Application Data
(60) Provisional application No. 62/803,685, filed on Feb. 11, 2019.

(51) Int. Cl. A01K 63/04; A01K 97/05; A01K 63/02

(52) U.S. Cl. CPC A01K 63/042; A01K 63/02; A01K 97/05

(57) ABSTRACT

An assembly for gently aerating a live bait tank using a portable air compressor as an air flow source, the assembly comprising an air diffusion end and air source connection end, the ends separated by a length of tubing for providing air from an air source to the diffusion end wherein the diffusion end is removably submerged in the live bait tank and the air source connection end is configured for removably coupling to a source of forced air.

### CROSS-REFERENCE TO RELATED APPLICATION

This application is based on and claims the benefit of U.S. provisional application Ser. No. 62/803,685, filed Feb. 11, 2019, the content of which is hereby incorporated in its entirety.

### BACKGROUND

The present invention relates aeration of a live bait storage container. More specifically, the present invention relates to a separable device for providing aeration to any live bait storage container or tank.

### SUMMARY

An aspect of the present disclosure relates to a portable system for aerating a bait container. For example, the system is portable in that it can be used with various bait containers. The system is separable from the bait container. Power for the system can be provided by any source of pressurized air such as an air compressor. The system is also separable from the air compressor.

Another aspect of the present disclosure relates to a portable system for aerating a fluid in a container. The system has an outlet end terminating in an air diffusion device and configured for submersion in the fluid and an inlet end for receiving an air flow from a source of pressurized air. A length of tubing connects the inlet end and the outlet end for providing air from the source of pressurized air to the outlet end for aerating the fluid.

The source of pressurized air is an air compressor. The tubing is removably coupled to the source of pressurized air and wherein the outlet end is removably submerged in the fluid. The system has an air flow regulating device to control a flow rate of air from the air compressor to the air diffusion end.

A connector between the air source and the inlet end has an air flow regulating device to control a flow rate of air from the air compressor to the air diffusion end. The flow regulating device comprises a ball valve.

The air diffusion end has one or more mechanisms for diffusing the pressurized air flow received from the source of pressurized air for providing air to the fluid. The air diffusion device is an air stone or an air disk.

The fluid is water and the container is configured to receive live bait for storage and transport of the bait.

Another aspect of the present disclosure relates to an assembly for aerating a live bait tank using a portable air compressor. The assembly has an air diffusion end and air compressor connection end, the ends separated by a length of tubing for providing air from the air compressor to the diffusion end. The diffusion end is removably submerged in the live bait tank and the air source connection end is configured for removably coupling to the air compressor and wherein a connection between the air compressor and the length of tubing comprises one or more air flow regulating mechanisms.

Yet another aspect of the present disclosure relates to a method for aerating a live bait tank using an air compressor as a source of air flow. Providing a portable system for providing air to water in the live bait tank includes the use of a portable system having an outlet end configured for submersion in the fluid and an inlet end configured for receiving an air flow from the air compressor with a length of tubing connecting the inlet end and the outlet end. The method includes removably coupling the inlet end to the air compressor and regulating the flow of air from the compressor to the outlet end for gently aerating the water in the live bait tank with the air compressor as the source of air flow.

The outlet end comprises an air diffusion device that is an air stone.

Regulating the flow of air from the compressor comprises using a ball valve in the length of tubing between the air compressor and the outlet end.

The method allows for utilizing a source of pressurized air where the air jet is directed through a conduit to an air diffusion end and regulated such that the pressurized air jet is distributed as a gentle flow to the water and thus the jet is provided to the water in a manner other than as a jet of air flow.

### BRIEF DESCRIPTION OF THE DRAWINGS

FIG. 1 is a perspective view of a portable system for aeration of a live bait holder.

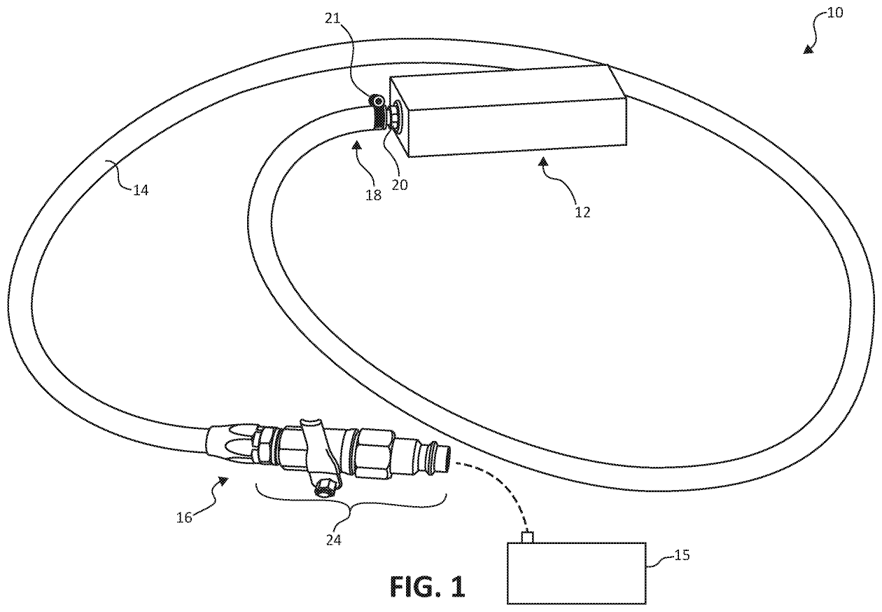

FIG. 2 is an exploded view of the system.

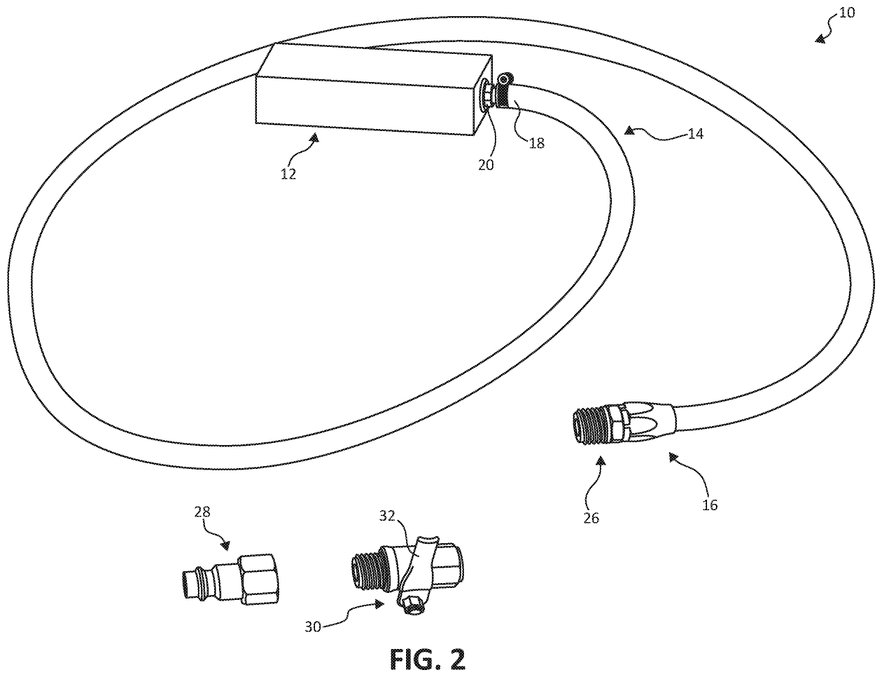

### DETAILED DESCRIPTION

A device for aerating a container holding a fluid is described herein. While embodiments of the device described herein are directed to aeration of a water tank or container for holding live bait therein, the aeration device may be used to aerate a fluid held in any various tank or container. The device described herein is also a portable and removable device for use with containers such as live bait containers.

The device for aerating a tank or container filled with water and for holding and/or transport of live bait is described generally at 10 in the figures. The device 10 is a portable assembly comprising an air diffusion end 12 and air source connection end 16, the ends 12 and 16 separated by a length of tubing 14 for providing air flow from an air source 15 to the diffusion end 12. The air source connection end 16 is configured for removable coupling to a source of forced air 15. The air diffusion end 12 is configured for removable submersion in a container of fluid such as water. The air diffusion end 12 is also configured to receive a flow or jet of pressurized air from the air source 15 and diffuse the air flow for distributing air into the water in which it is submerged thus gently aerating the water with a jet of air flow. The source of air flow or pressurized air may be an air compressor, including a portable air compressor. The assembly 10 described herein is a portable assembly 10 meaning that the assembly 10 can be used and re-used with different containers for holding, storing and/or transporting live bait and can be operably coupled to any convenient source of pressurized air.

In further detail, in one embodiment, the device 10 comprises an air diffusion end 12 which may terminate in connection to an air disk or an air stone operably connected to a length of tubing 14 for providing an air flow from a source 15, through the tubing, to the air diffusion end 12. The air diffusion end 12 is a device comprising one or more membranes which are configured to diffuse the air flow provided through the tubing through one or more areas of the air diffusion device. In one embodiment, the air diffusion end 12 is a porous stone which diffuses the air from the air source into the water. The air diffusion end 12 provides an increased surface are for diffusion of air for more easily aerating a container or tank of water holding live bait.

As illustrated in the figures, the air diffusion end 12 may be operably connected to a first end or outlet end 18 of the tubing 14 via one or more fasteners which may include a threaded connection 20 and/or a clamp 21 or similar mechanism(s) for operably and removable coupling the tubing 14 to the air diffusion end 12.

The length of tubing 14 may be flexible hose of varying length. Examples of flexible hosing include air compressor hoses, rubber hoses or other lengths of tubing having a wall capable of containing and directing a flow of pressurized air.

A second, opposing end also referred to as an inlet end of the tubing 14 is the air source connection end 16. The inlet end 16 may then be configured for removable connection with the source of air flow 15, examples of which may be an air compressor, air fan, or the like. In one embodiment, the inlet end 16 of the tubing 14 is coupled to a fitting 24 which comprises a first component 26 for securing to the tubing 14 and a second, separable component 28 having a first end for engaging with the first component 26 and a second end for engaging with a connecting end provided on the air source 15. A third component 30 such as an air flow regulating device may be inserted and coupled between the first component 26 and the second component 28. For example, a valve 30 such as a ball valve may be coupled to the first component 26 and to the second component 28 so as to connect these components in series and provide a flow regulation mechanism between the connection with the air source 15 and the tubing 14.

The components 26, 28, and 30 may connectable to one another via threaded engagements. That is, the inlet end of the length of tubing 14 is adapted for removable threaded connection with the first component 26, which is also threaded on an opposing end for connection with the valve 30. The components 26, 28, and 30 are provided with internal and/or external threads to enable the couplings between each of components 26 and 28 with component 30 and components 26 and 28 may be friction fit, threadedly connected or otherwise securely coupled to the tubing 14 and air source 15, respectively. This connection assembly is a fitting 24 that operably couples the tubing 14 to the air flow source 15 in a manner that can be manually regulated.

The source connector may be a component such as a male-end air compressor connector, configured to operably connect with the air compressor and allow air to flow through the connector and thus through fitting 28, to valve 30 and through fitting 26 to the tubing 14 for providing air through the air diffusion end 12. The valve 30 may be openable and closeable to selected positions via movement of handle 32, allowing a use to control the air flow from the air source 15. Components of fitting 24 described above and illustrated in the figures provide one embodiment of such a fitting 24 and variation in the size and style of connections comprising fitting 24 is not so limited.

The one or more air flow regulating mechanisms ensure the air flow through the tubing 14 and provided to the outlet end 12 is a uniform or consistent flow. For example, one mechanism may be an inline air flow regulator introduced into the assembly downstream of the source of pressurized air source. It is additionally or alternatively contemplated that the source of pressurized air can include a regulator for air flow and the mechanism is an additional inline regulator. Additionally or alternatively, and as illustrated in the figures, a valve 30 such as a ball valve may be incorporated for regulating the air flow from the air source 15 to the outlet end 12.

The air diffusion end 12 may be placed in any container or tank that is filled with water for holding live aquatic bait. When the air diffusion end 12 is submerged in the water in the container or tank and the inlet end 16 is operably secured to the air source 15, air is delivered to the container and diffused through the air diffusion end 12. The air source 15 may be a portable air compressor including air compressors of varying horse power in the range of 1 HP to 125 HP and/or in a range of tank sizes from 2 gallon tanks or more or 8 gallon tanks or more, or 11 gallon tanks or more, or 100 gallons or more. Thus, an air flow from an air compressor of most sizes, including larger sized a compressors can be regulated and used to gently aerate the water in which live bait is stored or transported without disturbing the bait or otherwise providing a turbulent motion to the water supply supporting the live bait. The air source 15 may essentially be any sized air compressor regardless of the amount of horsepower or tank size. The system described herein is designed to run off compressed air rather than a continuous air pump. Moreover, the air diffusion end 12 may be connected directly to the air source 15 or the air diffusion end need not be connected directly to the air source, for example, tubing as long as 100 feet or more in length can be used and connected between the air source 15 and the air diffusion end 12.

Although the present disclosure has been described with reference to preferred embodiments, workers skilled in the art will recognize that changes may be made in form and detail without departing from the spirit and scope of the disclosure.

1. A portable system for aerating a fluid in a container comprising:
an outlet end terminating in an air diffusion device and configured for submersion in the fluid;
an inlet end for receiving an air flow from a source of pressurized air;
a length of tubing connecting the inlet end and the outlet end for providing air from the source of pressurized air to the outlet end for aerating the fluid.

2. The system of claim 1, wherein the source of pressurized air is an air compressor.

3. The system of claim 1, wherein the air diffusion end comprises one or more mechanisms for diffusing the pressurized air flow received from the source of pressurized air for providing air to the fluid.

4. The system of claim 1, wherein the air diffusion device is an air stone.

5. The system of claim 1, wherein the air diffusion device is an air disk.

6. The system of claim 2, wherein the tubing is removably coupled to the source of pressurized air and wherein the outlet end is removably submerged in the fluid.

7. The system of claim 1, wherein the fluid is water and the container is configured to receive live bait for storage and transport of the bait.

8. The system of claim 2, wherein the system further comprises an air flow regulating device to control a flow rate of air from the air compressor to the air diffusion end.

9. The system of claim 2, wherein a connector between air source and the inlet end comprises an air flow regulating device to control a flow rate of air from the air compressor to the air diffusion end.

10. The system of claim 9, wherein the flow regulating device comprises a ball valve.

11. An assembly for aerating a live bait tank using a portable air compressor, the assembly comprising an air diffusion end and air compressor connection end, the ends separated by a length of tubing for providing air from the air compressor to the diffusion end wherein the diffusion end is removably submerged in the live bait tank and the air source connection end is configured for removably coupling to the air compressor and wherein a connection between the air compressor and the length of tubing comprises one or more air flow regulating mechanisms.

12. A method for aerating a live bait tank using an air compressor as a source of air flow, the method comprising:
providing a portable system for providing air to water in the live bait tank, wherein the portable system comprises an outlet end configured for submersion in the fluid and an inlet end configured for receiving an air flow from the air compressor with a length of tubing connecting the inlet end and the outlet end;
removably coupling the inlet end to the air compressor;
regulating the flow of air from the compressor to the outlet end; and
gently aerating the water in the live bait tank with the air compressor as the source of air flow.

13. The method of claim 12, wherein the outlet end comprises an air diffusion device that is an air stone.

14. The method of claim 12, wherein regulating the flow of air from the compressor comprises using a ball valve in the length of tubing between the air compressor and the outlet end.
